(19) United States
(12) Patent Application Publication
(10) Pub. No.: US 2012/0241376 A1
(43) Pub. Date: Sep. 27, 2012

(54) METHOD OF SELENIUM REMOVAL FROM AN AQUEOUS SOURCE

(76) Inventors: Robert Louis Baldwin, JR., Chapmanville, WV (US); Robert Louis Baldwin, SR., Chapmanville, WV (US); Thomas Charles Jageman, JR., Finleyville, PA (US); John Andrew Owsiany, McMurray, PA (US); Ryan Michael Schubenski, Avella, PA (US); Joseph Wayne Swearman, Markleton, PA (US)

(21) Appl. No.: 13/070,578

(22) Filed: Mar. 24, 2011

(51) Int. Cl. B01D 15/00; B01D 36/00

(52) U.S. Cl. 210/631; 210/295

(57) ABSTRACT

A process for removing selenium is described in which selenium is removed from an aqueous source for discharge into a lake, pond, river or stream by a combination of biological reduction of selenium followed by adsorption. The aqueous source first passes through a bioreactor which reduces the selenium compounds in solution to organic selenium and selenide. An adsorber, such as activated carbon, is then used to remove the organic selenium and selenide from solution. Optionally, a pump introduces a carbon source such as molasses to the bioreactor to initiate and sustain microbiological metabolic processes.

### FIELD OF THE INVENTION

This invention relates to a method for removal of selenium from water. More particularly, this invention relates to the use of a combination biological reduction process followed by an adsorption process to remove selenium from water.

### BACKGROUND OF THE INVENTION

Selenium is a commonly occurring element that is widely dispersed in rock and is frequently encountered in coal and coal mining influenced water. Selenium can be found in one of four oxidation states (Se⁺⁶, Se⁺⁴, SeO, and Se⁻²) and often is found as the water soluble ions selenate (SeO₄⁻²) and selenite (SeO₃⁻²). Elemental selenium (Se⁰) and the most reduced form, selenide (Se⁻²), are much less soluble in water. Selenium can be found in both inorganic and organic compounds.

Elevated levels of selenium in surface water bodies are potentially harmful to aquatic life. As a result, the federal Environmental Protection Agency as well as various state environmental regulatory bodies have promulgated standards to limit selenium content in lakes and streams. Under these standards, streams must have a maximum selenium content of 5 parts per billion (ppb).

One common technique to treat selenium-containing water is through chemical reduction. In a typical chemical reduction process, a reagent is contacted with an aqueous source to react with a selenium compound. However, such techniques are generally effective only with particular selenium compounds and often experience operating difficulties and/or are not economically viable.

A second technique to remove selenium from aqueous sources is adsorption. A demonstrated adsorptive technique, Ferrihydrite Co-Precipitation, has shown effectiveness in selenium removal, but not to concentrations as low as 5 ppb. Additionally, high operational costs, sludge disposal, and sludge stability concerns discourage use of this process. However, most adsorbent materials, including activated carbon, have been found ineffective in removing selenium, typically in the form of selenate and selenite, to the required levels.

Table 1 presented below presents the results of a series of tests performed on samples of aqueous samples containing selenium, mostly selenite and selenate. The samples were fed into a 55 gallon drum filled with granulated activated carbon. Measurements of the selenium content were taken of the feed going into the drum and of the discharge liquid exiting the drum. These tests showed inconsistent removal of the selenium which generally was insufficient to meet the 5 ppb discharge standards.

TABLE 1

Selenium (ppb)

| Sample Date | Feed | Carbon Drum |
|---|---|---|
| Jul. 06, 2010 | 9.3 | 2.75 |
| Jul. 08, 2010 | 9.37 | 8.31 |
| Jul. 09, 2010 | 9.39 | 9.22 |
| Jul. 12, 2010 | 9.42 | 7.3 |
| Jul. 14, 2010 | 11.2 | 8.22 |
| Jul. 15, 2010 | 11.4 | 9.15 |
| Jul. 20, 2010 | 13.3 | 11.2 |
| Jul. 21, 2010 | 11.7 | 9.85 |
| Jul. 22, 2010 | 11.9 | <1.62 |
| Jul. 23, 2010 | 12.8 | 3.91 |
| Jul. 26, 2010 | 11.3 | 10 |
| Jul. 27, 2010 | 11.9 | 12 |
| Jul. 29, 2010 | 11.3 | 10.2 |
| Aug. 04, 2010 | 10.6 | 8.62 |

A third technique to remove selenium from aqueous sources is biological reduction. It has been found that selenate and selenite can be reduced to elemental selenium and other reduced and organic forms in biological processes using certain microorganisms. Such a biological reduction process can be used to convert the soluble forms of selenium to insoluble elemental selenium which can then be precipitated out of solution. However, although this procedure removes a substantial amount of selenium from waste streams, unless the system is actively controlled, a significant amount of selenium remains in soluble form.

### SUMMARY OF THE INVENTION

Selenium can be removed from an aqueous source for discharge into a lake, pond, river or stream by a combination of biological reduction of selenium followed by adsorption. The aqueous source first passes through a bioreactor which reduces the selenium compounds in solution to elemental selenium, selenide and organic forms of selenium. An adsorber, such as activated carbon, is then used to remove the organic selenium and selenide from solution.

In the bioreactor, selenium is reduced to the elemental, organic and selenide forms through the action of anaerobic bacteria. In this biologic reduction process, selenium compounds such as selenate and selenite are reduced to elemental selenium, organic forms of selenium, and selenide. The selenide and any organic selenium that was present in the aqueous source largely remain in solution.

It has been unexpectedly found that residual soluble selenium from an anaerobic biological treatment system can be removed using an activated carbon adsorbent. Although such an adsorbent is not effective on the more oxidized forms of selenium, it has been found that the highly-reduced selenide and organic selenium compounds are readily adsorbed by activated carbon and effectively removed from an aqueous source.

It is to be understood that both the foregoing general description and the following detailed description are exemplary, but are not restrictive, of the invention.

### BRIEF DESCRIPTION OF THE DRAWING

The accompanying drawings incorporated in and forming a part of the specification illustrate several aspects of the present invention and, together with the description, serve to explain the principles of the invention. In the drawing:

FIG. 1 is a schematic representation of a flow chart of the presently preferred method of removing selenium compounds.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

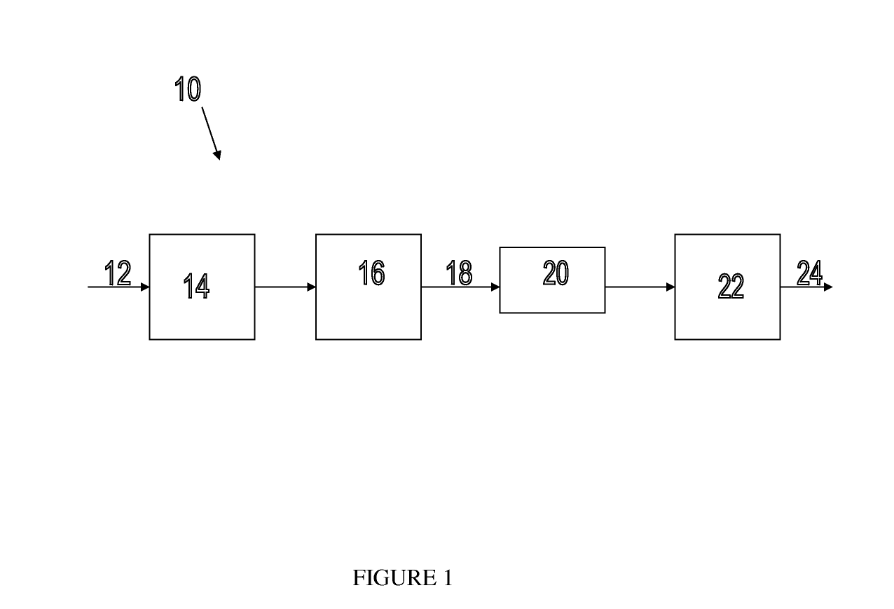

FIG. 1 shows a system 10 for removing selenium compounds from an aqueous source 12 such as coal mining influenced water. Aqueous source 12 includes selenium compounds such as selenate, selenite, elemental selenium, selenide and organic selenium compounds. At least a portion of the aqueous source 12 is introduced into a first bioreactor 14 filled with bacteria that will reduce the selenium compounds. Anaerobic bacteria naturally present in selenium rich aquatic environments have been found to be especially suitable. A second bioreactor 16 can be added if needed to further reduce the selenium compounds. Ideally, after the treatment in the bioreactors, the selenium compounds will primarily be in the form of elemental selenium, selenide and organic selenium compounds. Depending on the selenium content of aqueous source 12, additional bioreactors could also be added.

Upon exiting the bioreactors, the treated water 18 may be subjected to an ultraviolet light source 20 which is adapted to inactivate bacteria in the bioreactor discharge. The bioreactor discharge, with or without ultraviolet light treatment, is then introduced into an adsorption unit 22 preferably containing activated carbon such 12×40 Mesh, reagglomerated coal base virgin activated carbon. Additional adsorbing agents may also be used. Adsorption unit 22 will absorb the selenide and organic selenium compounds contained in the bioreactor discharge. Provided sufficient hydraulic residence time, such as 30 hours, to establish sufficient anaerobic conditions and biological activity to allow selenium reduction, and sufficient contact with suitable adsorbents, the treated discharge 24 will contain less than 5 ppb selenium.

Optionally, if desired, prior to feeding the aqueous source 12 into the first bioreactor 14, a pump injects a carbon source into bioreactors 14 and 16 to initiate and sustain microbiological metabolic processes. A dilute solution of molasses has been found to work well as a suitable carbon source. The addition of this carbon source has been found to enhance the ability of the anaerobic bacteria to biologically reduce the selenium.

Although the identity of the bacterium performing the selenium reduction has not been determined, it is currently believed that the bacterial species that perform selenium reduction overlap the bacterial species that perform nitrate reduction (also known as denitrifiers). Some research has been conducted to identify selenium reducing species based on 16s rDNA identification. These methods compare DNA found in samples to the DNA of known bacteria to identify bacterial species found in the sample. It is important to note that 16s rDNA methods only identify which bacteria are present in sample and do not necessarily identify which species are actively reducing selenium. The 16s rDNA results have shown that species capable of selenium reduction are very diverse, and can be found in three major phyla: Proteobacteria, Actinobacteria, and Fimicutes. There is also some evidence that a group of bacteria and archaea called haloalkaliphiles, which aren't frequently found in surface fresh water systems, may perform selenium reduction.

Some highlighted genera in the literature that are thought to reduce selenium, based on the 16s rDNA methods include: Bacillus spp., Pseudomonas spp., Enterobacter spp., Aeromonas spp., Brevundimonas spp., Staphylococcus spp., Arthrobacter spp., Paracoccus denitrificans, Planococcus spp., Serratia fonticola, Escherichia spp., Citrobacter braakii, Klebsiella spp., and Stenotrophomonas maltophilia.

### EXPERIMENTAL

The system of FIG. 1 was tested in a series of treatments conducted on a pilot scale basis. The system used two bioreactors (T-1 and T-2) containing bacteria naturally present in local selenium rich aquatic environments. Some of the experiments also included an activated carbon drum adsorber. Measurements were taken of the selenium content in the initial feed, at the exit of both bioreactors and at the final exit from the adsorber. Selenium content was measured by inductively coupled plasma mass spectroscopy (ICP-MS) which could not detect selenium contents less than 1.64 ppb. The conditions under which the experiments were conducted varied, but were typically in the following ranges:

| Condition | Range |
|---|---|
| Temperature | 40° F.-80° F. |
| Flow rate | 1 gallon/minute |
| Adsorber quantity | 180 lbs |

The data from the experiments is presented in Table 2 below.

TABLE 2

| | Selenium (ppb) | | | |
|---|---|---|---|---|
| Sample Date | Feed | Exit T-1 | Exit T-2 | Exit Carbon Drum |
| Apr. 08, 2010 | 27.5 | 26.3 | 20.9 | No Carbon Drum |
| Apr. 16, 2010 | 22.2 | 18.3 | 7.67 | No Carbon Drum |
| Apr. 20, 2010 | 19.8 | 11 | 6.38 | No Carbon Drum |
| Apr. 28, 2010 | 39.9 | 24.9 | 9.92 | No Carbon Drum |
| May 12, 2010 | 40.1 | 28.8 | 14.4 | No Carbon Drum |
| May 27, 2010 | 36.4 | 12 | 10.2 | No Carbon Drum |
| May 28, 2010 | 24.2 | 22.6 | 11.7 | No Carbon Drum |
| Jun. 10, 2010 | 19.1 | | 8.17 | No Carbon Drum |
| Jun. 15, 2010 | 19.6 | 8.15 | 5.62 | No Carbon Drum |
| Jun. 16, 2010 | 26.1 | 13.5 | 7.96 | No Carbon Drum |
| Jun. 17, 2010 | 21.4 | 18.1 | 8.85 | No Carbon Drum |
| Jun. 23, 2010 | 20.8 | 13.8 | 8.09 | No Carbon Drum |
| Jun. 30, 2010 | 26.3 | 16.2 | 8.36 | <1.64 |
| Jul. 02, 2010 | 38 | 22.8 | 7.97 | <1.64 |
| Jul. 06, 2010 | 34.1 | 17.7 | 10.5 | <1.64 |
| Jul. 07, 2010 | 30.4 | 26.9 | 10.5 | <1.64 |
| Jul. 08, 2010 | 32.4 | 19.1 | 9.42 | <1.64 |
| Jul. 12, 2010 | 28.9 | 20.8 | 9.01 | <1.64 |
| Jul. 13, 2010 | 29.0 | 19.7 | 7.55 | <1.64 |
| Jul. 14, 2010 | 32.4 | 20.5 | 8.02 | <1.64 |
| Jul. 28, 2010 | 32.7 | 18.2 | 11.4 | <1.64 |
| Jul. 29, 2010 | 27.5 | 24.4 | 16.1 | <1.64 |
| Aug. 05, 2010 | 22.8 | 19 | 13.6 | <1.64 |
| Aug. 06, 2010 | 25 | 19.2 | 12 | <1.64 |
| Aug. 09, 2010 | 26.7 | 21.2 | 10.2 | <1.64 |
| Aug. 11, 2010 | 27.2 | 18.7 | 9.76 | <1.64 |
| Aug. 12, 2010 | 21.9 | 22.6 | 11.9 | <1.64 |
| Aug. 13, 2010 | 27.7 | 14.5 | 12.5 | <1.64 |
| Aug. 16, 2010 | 20.5 | 14.6 | 11.2 | <1.64 |
| Aug. 26, 2010 | 23.1 | 20.7 | 13.6 | <1.64 |
| Aug. 27, 2010 | 22.5 | 14.2 | 11.2 | <1.64 |
| Aug. 31, 2010 | 24.9 | 17.4 | 16.3 | <1.64 |
| Sep. 01, 2010 | 25.5 | 16.8 | 13.1 | <1.64 |
| Sep. 09, 2010 | 22.2 | 17 | 10.9 | <1.64 |

As shown in Table 2, the bioreactors T-1 and T-2 did not sufficiently reduce the selenium content of the water. The typical sample exiting the bioreactors had a selenium content that was roughly on average twice the permissible amount of 5 ppb. However, when the biologically reduced samples were subjected to activated carbon adsorption, the discharge not only met the selenium content limits but, for the most part, was too low to be detected.

While not being bound to any particular theory of operation, the biological reduction of the selenium compounds to selenide and organic selenium compounds enhanced the ability of the activated carbon adsorber to remove the selenium compounds from the water. This can be seen by comparing the results in Table 1 with those in Table 2. As shown in Table 1, activated carbon is not adequate to remove selenate and selenite from the water source. However, as shown in Table 2, if the selenate and selenite is biologically reduced to selenide, then the activated carbon can remove the selenium from the water. Thus the combination of the biological reduction followed by adsorption with activated carbon accomplishes what neither biological reduction nor adsorption could do individually.

Although the invention is illustrated and described herein with reference to specific embodiments, the invention is not intended to be limited to the details shown. Rather, various modifications may be made in the details within the scope and range of equivalents of the claims and without departing from the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A process for removing selenium from an aqueous source containing selenium compounds comprising the steps of:
a. passing at least a portion of said aqueous source through a bioreactor, said bioreactor producing an aqueous stream containing organic selenium and selenide; and
b. passing at least a portion of said aqueous stream containing organic selenium and selenide through an adsorber.

2. The process of claim 1 wherein said absorber contains activated carbon.

3. The process of claim 1 further comprising the intermediate step of exposing at least a portion of said aqueous stream containing organic selenium and selenide to an ultraviolet light source.

4. The process of claim 3 wherein said absorber contains activated carbon.

5. The process of claim 3 wherein said bioreactor contains anaerobic bacteria capable of reducing selenium.

6. The process of claim 1 wherein said bioreactor contains anaerobic bacteria capable of reducing selenium.

7. The process of claim 6 further comprising the initial step of feeding a carbon source into said bioreactor.

8. The process of claim 7 wherein said carbon source is a dilute solution of molasses.

9. A system for removing selenium from an aqueous source containing selenium compounds comprising:
a. at least one bioreactor, said bioreactor reducing the selenium compounds and producing an aqueous stream containing organic selenium and selenide; and
b. an adsorber positioned to receive said aqueous stream containing organic selenium and selenide.

10. The system of claim 9 wherein said adsorber contains activated carbon.

11. The system of claim 9 further comprising an ultraviolet source to which at least a portion of said aqueous stream containing organic selenium and selenide is exposed.

12. The system of claim 11 wherein said adsorber contains activated carbon.

13. The system of claim 11 wherein said bioreactor contains anaerobic bacteria capable of reducing selenium.

14. The system of claim 9 wherein said bioreactor contains anaerobic bacteria capable of reducing selenium.

15. The system of claim 14 further comprising a pump for feeding a carbon source into said at least one bioreactor.

16. The system of claim 15 wherein said carbon source is a dilute solution of molasses.
